(19) United States
(12) Patent Application Publication
(10) Pub. No.: US 2018/0251254 A1
(43) Pub. Date: Sep. 6, 2018

(54) Collapsible bottle

(71) Applicant: N.V. Nutricia, Zoetermeer (NL)

(72) Inventors: Stefanie José Groot, Amsterdam (NL); Peter Kuhn, The Hague (NL)

(73) Assignee: N.V. Nutricia, Zoetermeer (NL)

(21) Appl. No.: 15/756,076

(22) PCT Filed: Aug. 29, 2016
(86) PCT No.: PCT/NL2016/050599

§ 371 Date: Feb. 28, 2018

(30) Foreign Application Priority Data
Aug. 28, 2015 (NL) PCT/NL2015/050599

(51) Int. Cl. B65D 1/02; A61J 1/14; A61J 9/00

(52) U.S. Cl. CPC B65D 1/0292; B65D 23/003; A61J 9/005; A61J 1/1493

(57) ABSTRACT

A collapsible bottle for enteral feed has a thin-walled body extending axially from a base to a neck and having a front, a back and two sides that define a width dimension of the bottle. The body has a shoulder region adjacent to the neck, a hip region adjacent to the base and a waist region therebetween and the circumference of the bottle in the waist region is less than the circumference of the bottle in both the hip region and the shoulder region. The bottle is provided with hinge columns that extend between the hip region and the shoulder region at the sides of the bottle. The hinge columns provide the wall of the body with a region of increased stiffness in the axial direction while facilitating bending of the wall about the hinge column.

### BACKGROUND OF THE INVENTION

### 1. Field of the Invention

The present invention relates to collapsible bottles and more particularly to collapsible bottles for receiving and dispensing feeding solutions of the form used for enteral feeding of patients. The invention further relates to a method of manufacture of such a bottle.

### 2. Description of the Related Art

Various forms of package are well known for receiving medical solutions. These range from bags and pouches, frequently used for infusion purposes to bottles and boxes. Typical of many medical solutions is that they should be administered by gravity or by a dosing pump, requiring the package to be hung upside down from a suitable stand. In the past, bags and pouches have been considered as collapsible. This usually means that dispensing of their contents can take place without any need for entry of air into the package interior. This has obvious advantages for maintaining sterility although such bags and pouches may be less convenient to stack and handle, due to their flexible nature.

Bottles and boxes have previously been largely considered as rigid in that they can maintain their form during transport and use. This means that as they are emptied, air must be allowed into the package to maintain its shape. More recently, thin-walled bottles have been developed that can initially maintain their shape during storage and transport but can nevertheless collapse in use to dispense their content without requiring air to be admitted. One such bottle is described in US2011/0240673. This bottle has a body portion constructed and arranged to collapse by folding along outwardly extending creases when the volume of the interior space is reduced. It may be manufactured by blow moulding, by extruding a parison of plastic material, capturing a portion of the parison within a mould and inflating the portion of the parison that is within the mould against the walls of the mould to fabricate the specific shape of the container.

Although existing bottle designs have allowed collapse to take place, they have been rather limited in terms of their shape. Furthermore, as the bottles become more flexible, stability of the bottle becomes more critical and gripping becomes more difficult, especially when the bottle is not quite full or when the surface of the bottle or hands of a user are wet. It would be desirable to provide a bottle that permits collapse during emptying but which still remains easy to handle.

### SUMMARY OF THE INVENTION

According to the invention there is provided a collapsible bottle for liquid food, comprising a thin-walled body extending axially from a base to a neck and having a front, a back and two sides that define a width dimension of the bottle, the base being provided with an integrally formed tab for hanging the bottle neck-down, the body having a shoulder region adjacent to the neck, a hip region adjacent to the base and a waist region therebetween, wherein a circumference of the bottle in the waist region is less than a circumference of the bottle in both the hip region and the shoulder region the bottle further comprising hinge columns extending at the sides of the bottle in at least the waist region, the hinge columns providing the wall of the body with a region of increased stiffness in the axial direction. while facilitating bending of the wall about the hinge column.

### DETAILED DESCRIPTION OF THE INVENTION

In the present context, liquid nutritional products may be any liquid product to be consumed orally or by enteral tube feeding. The term “collapsible” defines a feature of the bottle that is very important for the delivery of liquid nutritional products. Collapsibility is important since when a collapsible bottle with a liquid nutritional composition is being emptied there is no need to let air into the bottle that could otherwise block the flow of the liquid nutritional product from the bottle due to vacuum. Air supply into the bottle is unwanted since this air could potentially carry microorganisms. Nutritional products administered as tube feeds may take many hours to administer to the patient and therefore contamination by microorganisms in the liquid nutritional products should be prevented.

Collapsibility is defined as the decrease in volume of the bottle when the bottle is fully emptied. This volume decrease is more than 70%, preferably more than 75% even more preferably at least 80% of the initial volume of the bottle. When the bottle according to the invention is emptied, the bottle will collapse, and at least 95% of the content should be released from the bottle, preferably at least 97.5% of the content, or even more preferably at least 99% of the liquid content of the bottle is released from the bottle without the need to let in air into the bottle. The overall volume decrease will depend also on the initial head space.

The initial head space is the volume inside the bottle that is not filled with the liquid. Since no air enters during use, the absolute head space will remain substantially constant during emptying although the relative head space will increase. The better collapsible is the bottle, the less head space will be needed. Preferably the head space in the bottle according to the present invention is less than 200 ml, more preferably less than 150 ml and even more preferably less than 100 ml. In one preferred embodiment the head space is between 150 ml and 25 ml, even more preferably between 125 ml and 50 ml and most preferably between 100 ml and 50 ml. A certain volume of headspace is necessary in order to release the entire product from the bottle when the bottle is used to supply enteral tube nutrition that is administered with the force of gravity. When a pump is used to administer the liquid from the bottle, a lower head space volume could still be sufficient. In this case a head space of between 25 ml and 75 ml would still be sufficient to release the product from the bottle. A lower head space is advantageous since this will increase the shelf life of the product if the head space includes oxygen. Moreover, a low head space is advantageous since this will decrease the overall size of the bottle, including the amount of material needed for the bottle and the number of bottles fitting on a transportation pallet. The gas present in the head space can be air or an inert gas like nitrogen or mixtures thereof. It may be noted that although a filler machine may “fill” the head space with an inert gas such as nitrogen, this will generally always include some oxygen. It is therefore desirable to limit the headspace in the interests of overall oxygen reduction.

According to the invention, the bottle is provided with hinge columns extending between the hip region and the shoulder region at the sides of the bottle. In the present context, the term hinge column is intended to refer to an element or region of the wall that facilitates bending of the wall about a first axis while increasing the stiffness of the wall about axes being perpendicular to the first axis. In the present case the first axis may be an axis lying parallel to the axial direction of the bottle.

The actual thickness of the wall will be determined by the desired wall strength and collapse properties. This also depends on the material used. In one embodiment, the wall thickness in the waist region of the front and back panel may be between 0.2 mm and 0.6 mm, preferably between 0.3 mm and 0.5 mm. These values have been found suitable for use with polyethylene (PE) and in particular LDPE. It should be noted that such a construction leads to bottles with very flexible walls that are substantially less rigid than typical bottles used in the consumer markets e.g. for water or soft drinks. The thickness may also vary over the height of the bottle and may be lower in the shoulder region than in the waist region.

According to an embodiment, the wall in the waist region does not show any abrupt variations in thickness around the circumference, such as thickened ribs or lines of weakness. The wall may be substantially constant in thickness around the circumference. In this context, substantially constant in thickness is intended to denote that the variation is that which would be expected for a blow-moulded bottle of non-circular cross-section. Typical wall thickness variation may be less than a factor of two around the circumference. In one embodiment e.g. using polyethylene the wall in the waist region may have an average thickness wherein the front and back are at least 1.4, preferably 1.5 more preferably at least 1.6 times thicker than the sides.

Preferably the variation between the front and back panels and the variation between the side panels is minimal (<20%). In another preferred embodiment using PE the wall thickness in the waist region of the front and back panel is between 0.2 mm and 0.6 mm, preferably between 0.3 mm and 0.5 mm. These values may be different depending on the material used and the overall cross-sectional shape. The skilled person in the field of blow moulding will be aware that unless measures are taken to compensate in the parison, wall thickness may vary with the inverse of the radial distance by which the wall expands. For a bottle of oval or oblong cross-section the wall thickness at the shorter sides may be at least 50% less thick than the wall thickness on the longer sides. This may also be desirable to achieve sufficient strength and collapsibility.

The hinge columns may comprise bowed or curved wall sections, as seen when viewed axially in cross-section. In one embodiment, they may be curved to a radius of between 1 mm and 5 mm over an arc of at least 90°, preferably an arc of between 120° and 240°, most preferably, around 180°. The radius may refer to the inner radius i.e. the smallest radius, although this need not necessarily be at an inside of the wall. It will be understood that the radius and the arc refer to the situation when the bottle is in its uncollapsed condition i.e. filled with fluid or prior to filling. As the bottle collapses, the radius and the arc length may change. Other than at the hinge columns, the front, back and sides of the bottle may be generally smooth without sharp curves or radii, at least being curved with a radius that is significantly greater than the radius that defines the hinge columns.

As indicated above, the hinge columns may comprise bowed or curved regions of the wall that may curve inwards or outwards i.e. the outer surface may be convex or concave at that location. In one preferred embodiment the hinge columns comprise inwardly protruding i.e. concave hinge columns having the advantage of not having any protruding parts that would form weak points or occupy space when packaging more bottles in a box. In addition an advantage of the concave hinge columns is that the concave hinge columns remain open for passage of fluid between the shoulder region and the hip region even after collapse of the bottle. This ensures adequate flow of fluid from the hip region to the shoulder region even as the waist region collapses.

In one advantageous form of the bottle, the width of the bottle at the waist region is less than at the shoulders or the hips. Such a waisted or organic shape is generally desirable in terms of improved grip and a more desirable form. Nevertheless, prior to the present invention, it was not possible to achieve the desired controlled collapse in such a waisted shape since the variation of cross-section along the axis of the bottle led to twisting and distortion during the process of collapse. In one embodiment, the width of the bottle at the waist region is at least 3%, preferably at least 5% less than at the shoulders or the hips. The waist region may even be as much as 10% narrower than at the shoulders and hips, These values are given for the bottle in its uncollapsed state. There may also be just one single waist region i.e. a single point of minimal width between a single pair of shoulders and hips.

By including the presently defined hinge columns, increased stability may be achieved and the bottle may remain straight during collapse e.g. with the hinge columns parallel to the axial direction of the bottle. In one embodiment, the bottle may retain a stable form that can stand upright on its base even in a partially collapsed state while the liquid volume in the bottle remains above 20% of its initial volume. A partially used bottle may then be returned to a refrigerator and stored as desired in an upright state. In one embodiment, the bottle may retain a stable form and may even be stood on its base when it is completely emptied of liquid. The shoulders have preferably the same dimensions as the hips in order to maximise space during packing.

The hinge columns extend between the hip region and the shoulder region at the sides of the bottle and may have a constant cross-sectional shape along their length or may vary in cross-section and hence in their reinforcing properties. In one embodiment, the hinge columns extend only in the waist region i.e. they do not pass the point in the shoulder region at which the width of the bottle decreases towards the neck. The hinge columns may extend over at least half of the total height of the bottle, including the neck i.e. in the axial direction. In absolute terms, the hinge columns may extend at least 80 mm in the axial direction. For larger bottles of about 1000 ml capacity, the hinge columns may extend at least 140 mm in the axial direction. Bottles of from 500 ml to 1000 ml are contemplated but the skilled person will be aware that bottles of other dimensions may also benefit from the principles described herein.

The bottle is generally of a form suitable for use in dispensing and storage of enteral feeding solutions and may be provided with a closure suitable for such use. In one preferred form, the neck may be provided with a screw thread to receive a closure, which may also be used to connect the bottle to an appropriate administration set.

As administration generally takes place with the bottle suspended from a support or stand, the base of the bottle is preferably provided with an integrally formed tab for hanging the bottle neck-down. In an embodiment, the tab is hingedly connected to the base of the bottle with a living hinge. The living hinge may extend across the base of the bottle from the front to the back, allowing a relatively large tab to be located within the base region. This configuration is achievable by moulding the bottle in a mould that has a seam around the front and back of the bottle rather than at the sides as will be described in further detail below. Avoiding a seam at the sides of the bottle may also be beneficial for the construction of the hinge columns.

As indicated above, a preferred method of manufacture of such bottles is by blow-moulding from an extruded parison. The bottle is preferably formed from a thermoplastic polymer such as polyethylene, in particular MDPE although LDPE or HDPE may also be used. The skilled person will nevertheless understand that any other suitable polymer material may also be employed that is capable of achieving the desired flexibility including PET, PVC and PP. The bottle according to the invention or at least the body thereof, is preferably formed of a laminate material, in particular comprising an oxygen barrier layer such as EVOH or the like. Such laminated bottle is particular suitable for (medical) liquid nutritional products with a long shelf life. The bottle may be transparent or opaque, depending on preference and the nature of the substance to be delivered.

As also indicated above, the thickness of the wall and the geometry of the body will be determined by the desired collapse properties. In one desired configuration, the body may be arranged to collapse from an initial volume to a final volume when the interior of the bottle is subjected to an under pressure of less than 60 mBar, preferably 50 even more preferably 40 mBar. The final volume may be defined as being less than 70% of the initial volume.

The bottle may also be designed such that the body collapses asymmetrically from one side towards the other side. This may be achieved by ensuring a slight variation in wall thickness between left side and the right side. The invention further relates to a bottle as defined above or hereinafter comprising a quantity of enteral feeding solution within the body and a screw closure sealed to the neck. A sealing foil may also be provided to close the neck during storage, removable or pierceable prior to use.

The invention also relates to a method of manufacturing a collapsible bottle for enteral feed, the method comprising extruding a tubular parison of thermoplastic material; blowing the parison within a mould to form a thin-walled body extending axially from a base to a neck and having a front, a back and two sides that define a width dimension of the bottle, the body having a shoulder region adjacent to the neck, a hip region adjacent to the base and a waist region therebetween, the bottle further comprising hinge columns extending between the hip region and the shoulder region at the sides of the bottle, the hinge columns providing the wall of the body with a region of increased stiffness in the axial direction while facilitating bending of the wall about the hinge column. The bottle may be otherwise as described above or hereinafter.

The invention also relates to a mould having a form corresponding to the bottle as described above or hereinafter.

### BRIEF DESCRIPTION OF THE DRAWINGS

The features and advantages of the invention will be appreciated upon reference to the following drawings of a number of exemplary embodiments, in which:

FIG. 1 shows a perspective view of a bottle for enteral feed according to a first embodiment of the present invention;

FIG. 2 shows a cross-section through the waist region of the bottle of FIG. 1;

FIG. 2A is a detail of part of the cross-section of FIG. 2;

FIG. 3 shows a perspective view of the bottle of FIG. 1 during administration of enteral fluid; and

FIG. 4 shows a cross-section through the waist region of the bottle of FIG. 3;

FIG. 5 shows a perspective view of the bottle of FIG. 1 in an almost collapsed configuration;

FIG. 6 shows a cross-section through the waist region of the bottle of FIG. 5;

FIGS. 7A to 7C show cross-sections through a conventional bottle during collapse;

FIG. 8 shows a cross-section through the waist region of a bottle according to an alternative embodiment of the invention; and

FIG. 9 shows a perspective view of a mould for producing a number of bottles according to the invention.

### DESCRIPTION OF ILLUSTRATIVE EMBODIMENTS

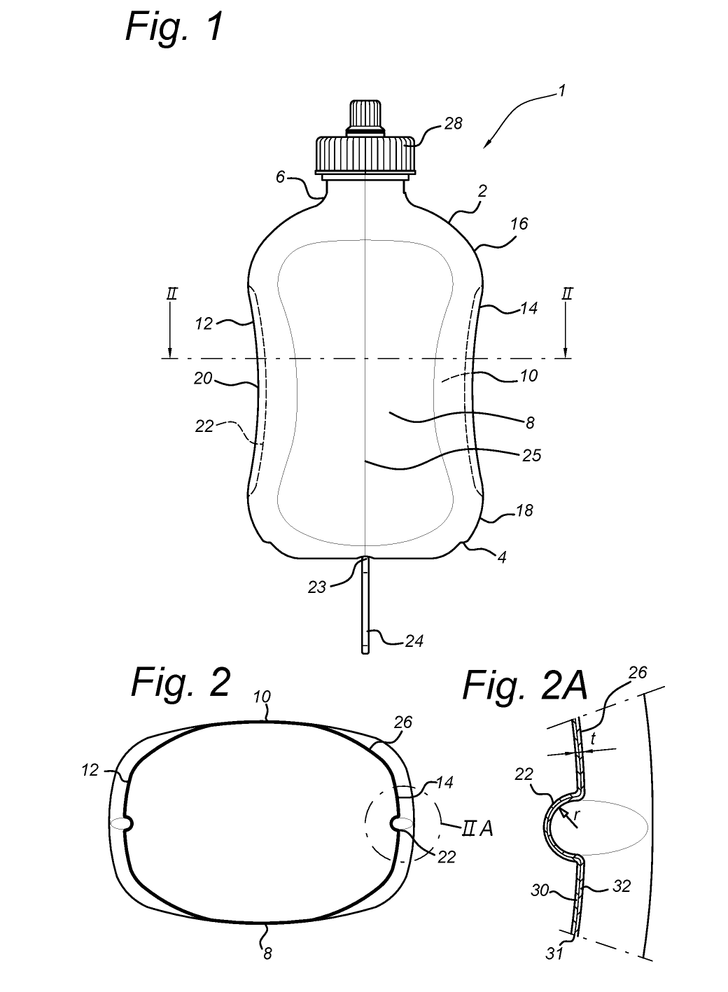

FIG. 1 shows a perspective view of a bottle 1 for enteral feed according to the present invention. The bottle 1 comprises a thin-walled body 2 having a base 4 and a neck 6. The body 2 has a front 8, a back 10, a left side 12, a right side 14. The body 2 has a shoulder region 16 adjacent to the neck 6, a hip region 18 adjacent to the base 4 and a waist region 20 between the hip region 18 and the shoulder region 16. The bottle 1 further includes hinge columns 22 that extend between the hip region 18 and the shoulder region 16 along the sides 12, 14 of the bottle 1, as will described further below. A tab 24 is integrally formed with the base 4 and connected thereto at a living hinge 23. A screw closure 28 is applied to the neck 6. A seam 25 can be seen extending up the front 8 of the bottle 1, aligned with the tab 24. The seam 25 also extends down the back 10.

FIG. 2 shows a cross-sectional view through the bottle 1 at the waist region 20, taken in direction II-II in FIG. 1. As can be seen in FIG. 2, the wall 26 at this section is a generally oval shape having a flattened front 8 and back 10. The hinge columns 22 at the left and right sides 12, 14 are in the form of hemispherical grooves that are concave with respect to the outer surface of the bottle 1. The remainder of the cross-section is convex. In the illustrated embodiment according to FIGS. 1 and 2, the bottle 1 has a volume of 650 ml and the width and depth at the waist region 20 are approximately 85 mm and 55 mm respectively.

FIG. 2A is an enlarged view of the hinge column 22 of FIG. 2. The wall 26 has a thickness t of around 0.3 mm. This thickness is constant around the whole circumference of the waist region to a tolerance of +−0.1 mm. In fact, measurements have shown that the thickness varies from around 0.4 mm at the front 8 and back 10 to a value of around 0.2 mm at the left side 12 and right side 14. The wall 26 is formed of inner and outer layers 30, 32 of polyethylene with a barrier layer 31 of EVOH therebetween. At the hinge column 22, the wall 26 is curved inwards with a radius r of 2.0 mm over an arc of around 180°.

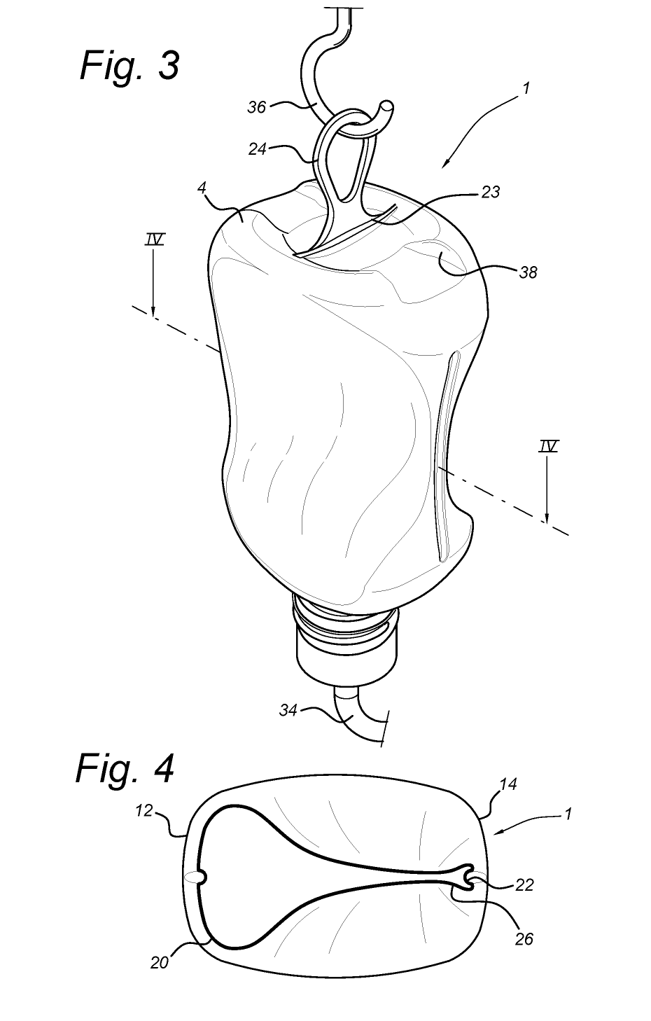

FIG. 3 shows a perspective view of the bottle 1 of FIG. 1 during administration of enteral fluid through an administration set 34. The bottle 1 is suspended upside-down by tab 24 from a support 36. The bottle 1 is in a partially collapsed condition. Also visible in this view are recesses 38 in the base 4, which are shaped to receive and retain the tab 24 when it is folded flat about the living hinge 23. The orientation of the tab 24 across the base 4 of the bottle 1 allows the tab 24 to be relatively large and yet still fit within the recesses 38 for storage. A larger tab 24 is more convenient for hanging.

FIG. 4 shows a cross-section through the waist region 20 of the partially collapsed bottle 1 along line IV-IV of FIG. 3. As can be seen, the bottle 1 has collapsed at the right side 14 but is not collapsed at the left side 12. The hinge column 22 at the right side 14 has facilitated this collapse by allowing the wall 26 to bend at this point around the hinge column 22. Despite this collapse, the hinge column 22 maintains its concave shape and acts as a relatively rigid elongate reinforcement along the right side 14 of the bottle 1, preventing the bottle 1 from buckling or folding at this point about the cross-section.

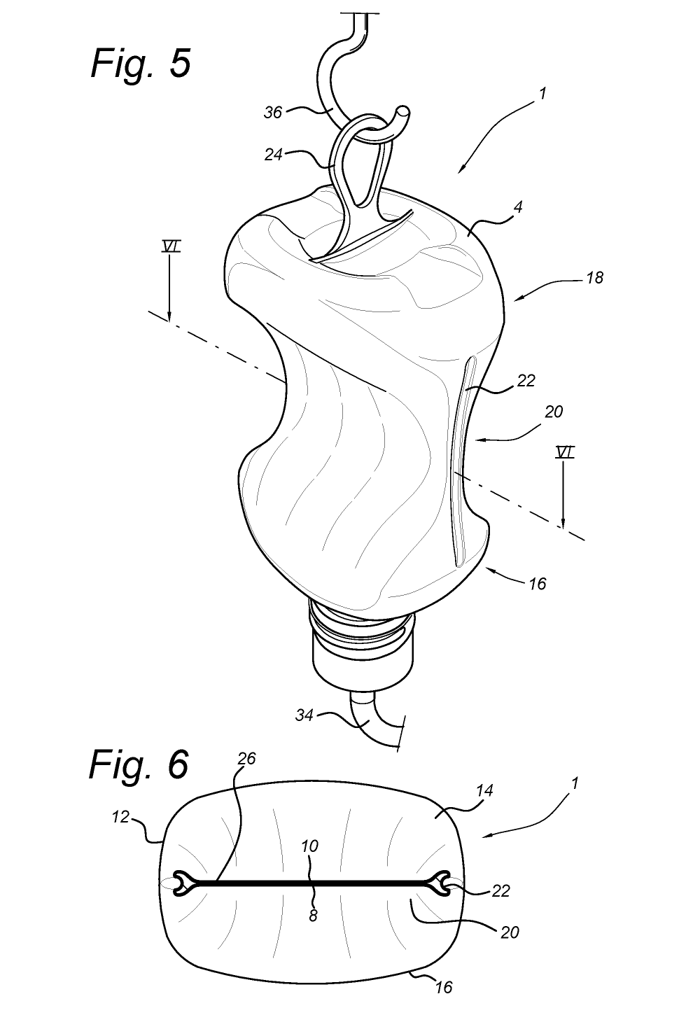

FIG. 5 shows a perspective view of the bottle 1 of FIG. 1 in a further stage of collapse when around 80% of the liquid in the bottle 1 has been administered. At this point, the waist region 20 has collapsed completely but the hip region 18 and the shoulder region 16 retain their shape and some fluid may remain in the hip region 18. Furthermore, the column strength of the hinge columns 22 ensures that the bottle 1 remains relatively straight and if administration is discontinued at this point, the bottle 1 is relatively stable and can be stood on its base 4.

FIG. 6 shows a cross-section through the waist region 20 of the bottle 1 of FIG. 5 along line VI-VI. In this case, the wall 26 has collapsed completely and the front 8 and back 10 engage one another. Nevertheless, the hinge columns 22 remain partially open allowing fluid to pass between the hip region 18 and the shoulder region 16 should this be required.

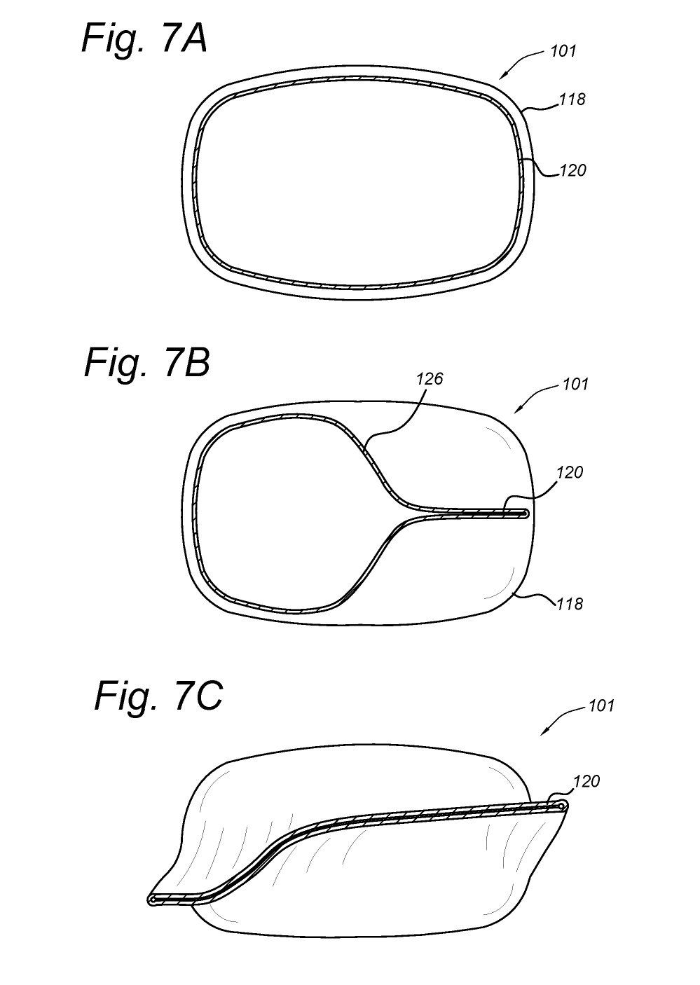

FIG. 7A shows a cross-section of a similar sized bottle 101, looking towards the hip region 118. The bottle 101 has a plain oval waist region 120 without hinge columns or other variations in the cross-section. In FIG. 7B, the bottle 101 is shown partially collapsed. In this case, the bottle 101 collapses completely at the right side and the wall 126 loses its structural strength in the axial direction of the bottle 101. This tends to cause the bottle 101 to fold or bend at its waist region 120 with respect to the hip region 118. In FIG. 7C the bottle 101 has further collapsed to the point that the waist region 120 is flattened. In this state, the waist region 120 has hardly any axial rigidity and can fold and distort uncontrollably. Furthermore, as the waist region 120 is completely collapsed it can no longer allow fluid to pass.

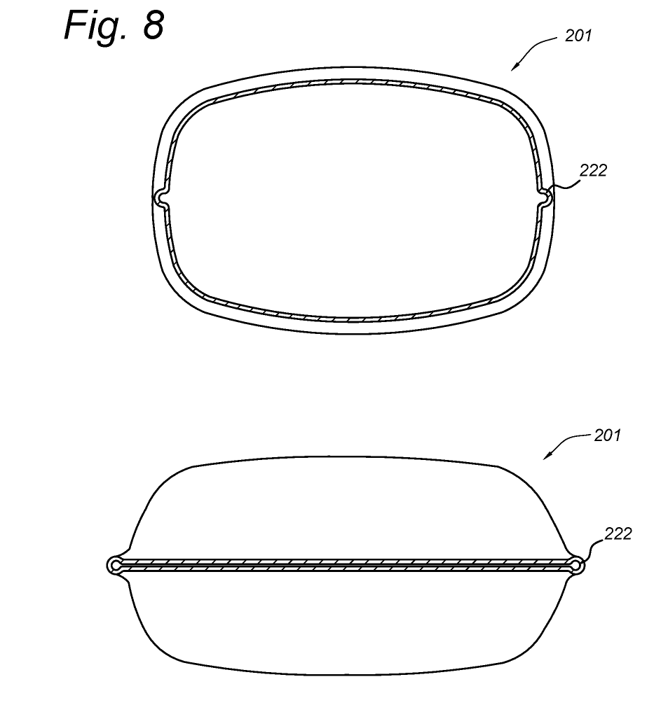

FIG. 8A is a cross-section of a bottle 201 according to a second embodiment of the invention. In this embodiment, instead of being concave, the hinge columns 222 are convex. FIG. 8B shows the bottle 201 in collapsed state, illustrating how the hinge columns 222 remain open to allow passage of fluid and ensure structural strength along the sides of the bottle 201.

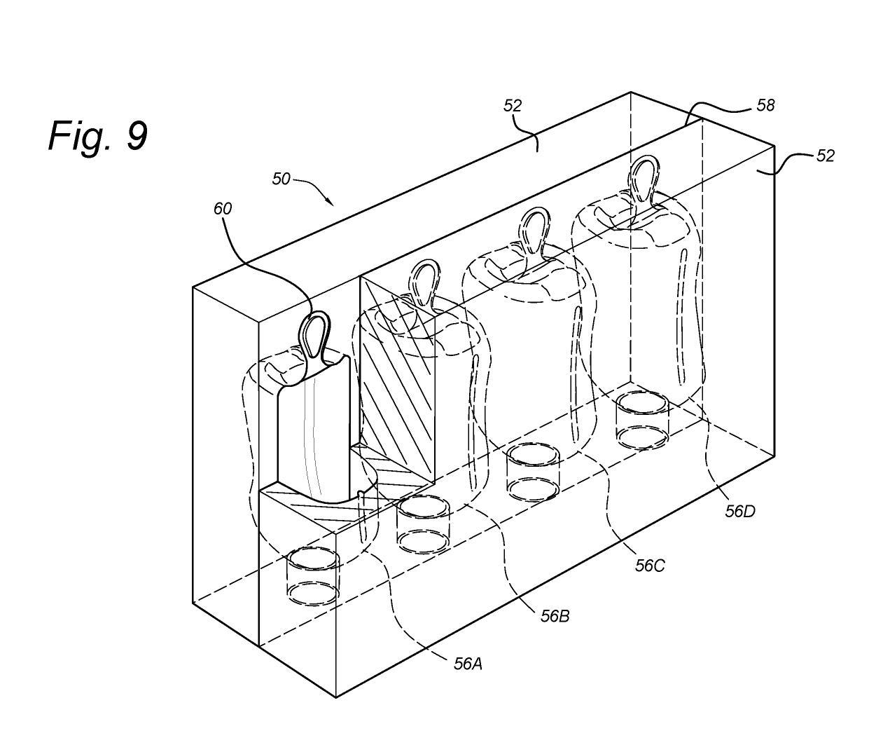

FIG. 9 shows in schematic perspective view a mould 50 for producing a bottle as shown in FIG. 1. Other items required for performing blow moulding are omitted for the sake of clarity although the skilled person will understand that in this view, connection for a blow pin may be provided at an underside of the mould 50. The mould 50 comprises two mould-halves 52, 54 of which mould-half 54 is partially cut-away to better envisage the mould cavities 56A-D. In the illustrated embodiment, four mould cavities 56A-D are provided although it will be understood that a larger or lesser number is also contemplated. The mould-halves 52, 54 meet at a joint 58.

According to the invention, the cavities 56A-D are oriented with respect to the mould halves 52, 54 so that the joint 58 is aligned with a tab portion 60, which forms the tab 24 during moulding. The cavities 56A-D are therefore located side-by-side such that bottles 1, formed within the cavities 56A-D will have their fronts 8 and backs 10 facing each other and the seam 25 will be formed by the joint 58 across these fronts 8 and backs 10. This side-by-side orientation is advantageous in terms of enabling multiple bottles to be formed in a single mould and also in ensuring that the tab is aligned with the minor dimension of the bottle.

Thus, the invention has been described by reference to certain embodiments discussed above. It will be recognized that these embodiments are susceptible to various modifications and alternative forms well known to those of skill in the art. In particular, the hinge columns may be distinct from the schematically illustrated designs and may vary over their length and also between the left side and the right side of the bottle.

Modifications in addition to those described above may be made to the structures and techniques described herein without departing from the spirit and scope of the invention. Accordingly, although specific embodiments have been described, these are examples only and are not limiting upon the scope of the invention.

1.-23. (canceled)

24. A collapsible bottle for liquid enteral nutrition, comprising a body extending axially from a base to a neck and having a front, a back and two sides that define a width dimension of the bottle, wherein the bottle can stand upright on its base with the base being provided with an integrally formed tab for also hanging the bottle neck-down, the body having a shoulder region adjacent to the neck, a hip region adjacent to the base and a waist region therebetween, wherein a circumference of the bottle in the waist region is less than a circumference of the bottle in both the hip region and the shoulder region, the bottle further comprising hinge columns extending at the sides of the bottle in at least the waist region, the hinge columns providing the wall of the body with a region of increased stiffness in the axial direction while facilitating collapse by bending of the wall about the hinge column.

25. The bottle according to claim 24 wherein the bottle comprises polyethylene (PE).

26. The bottle according to claim 24, wherein the body consists of a PE/EVOH/PE laminate.

27. The bottle according to claim 24, wherein the wall in the waist region has an average thickness at the front and back that is at least 1.4 times thicker than an average thickness at the sides.

28. The bottle according to claim 24, wherein the wall thickness in the waist region of the front and back panel is between 0.2 mm and 0.6 mm.

29. The bottle according to claim 24, wherein the hinge columns are inwardly protruding curved wall sections and wherein the wall sections are curved to a radius of between 1 mm and 5 mm over an arc of at least 90°.

30. The bottle according to claim 24, wherein the width of the bottle at the waist region is at least 3% less than at the shoulders or the hips.

31. The bottle according to claim 24, wherein the hinge columns extend throughout the waist region and terminate adjacent to a widest location of the shoulder region and hip region respectively and wherein the hinge columns extend over at least half of the height of the bottle.

32. The bottle according to claim 24, wherein the neck is provided with a screw thread to receive a closure.

33. The bottle according to claim 24, wherein the body is of thermoplastic material, blow-moulded from an extruded parison.

34. The bottle according to claim 24, wherein the body is arranged to collapse from an initial volume to a final volume when the interior of the bottle is subjected to an under pressure of less than −60 mBar, the final volume being less than 30% of the initial volume.

35. The bottle according to claim 24, wherein the body is arranged to collapse when the interior of the bottle is subjected to an under pressure, whereby collapse occurs asymmetrically from one side towards the other side.

36. The bottle according to claim 24, wherein the body is arranged to collapse when the interior of the bottle is subjected to an under pressure, whereby in the collapsed state, the hinge columns remain open for passage of fluid between the shoulder region and the hip region.

37. The bottle according to claim 24, wherein in a partially collapsed state when the volume of the bottle is 20% of its initial volume, the bottle retains a stable form that can stand upright on its base.

38. The bottle according to claim 24, comprising a quantity of enteral feeding solution within the body and a screw closure sealed to the neck.

39. A mould having a form corresponding to the bottle according to claim 24.

40. The mould according to claim 39, comprising two mould sections that join together to form a seam at the location of the front and back of the bottle.

41. A method of manufacturing a collapsible bottle for enteral feed, the method comprising:
extruding a tubular parison of thermoplastic material;
blowing the parison within a mould to form a thin-walled body extending axially from a base to a neck and having a front, a back and two sides that define a width dimension of the bottle, the body having a shoulder region adjacent to the neck, a hip region adjacent to the base and a waist region therebetween, the bottle further comprising hinge columns extending between the hip region and the shoulder region at the sides of the bottle, the hinge columns providing the wall of the body with a region of increased stiffness in the axial direction while facilitating bending of the wall about the hinge column in use, during collapse of the bottle.

42. The method according to claim 41, wherein the bottle is a bottle according to claim 24.

43. The bottle according to claim 24, wherein the bottle is adapted to dispense a liquid and wherein the liquid exits the bottle without air entry such that the bottle collapses in the region between the hinge columns.
